(19) United States
(12) Patent Application Publication
(10) Pub. No.: US 2004/0245069 A1
(43) Pub. Date: Dec. 9, 2004

(54) Method of variable pitch-spacing and turning of work pieces

(75) Inventors: Jeremy Frederic Hook, Hyde Park, OH (US); Jeffrey Hale Blumenthal, Anderson Twp., OH (US); Richard George Coe, Anderson Twp., OH (US); Dennis Allen DeHaan, Liberty Twp., OH (US); Michael Joseph Page, Springfield Twp., OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/761,640

(22) Filed: Jan. 21, 2004

(51) Int. Cl. B65G 29/00; B65G 47/24; B65G 47/84

(52) U.S. Cl. 198/459.1; 198/459.2; 198/459.8; 198/377.04

(57) ABSTRACT

A method and an apparatus for variable-pitch spacing and turning or, reversibly, for turning and variable-pitch spacing of work pieces in production of disposable absorbent articles, such as, feminine hygiene articles, diapers, body wraps, and the like, are disclosed. The work pieces can include any component of a disposable absorbent article, a combination of components forming a semi-finished absorbent article, or a finished absorbent article product.

### FIELD OF INVENTION

The present invention relates to a method of variable pitch-spacing and turning or, reversibly, turning and pitch-spacing work pieces in production of disposable absorbent articles including feminine hygiene articles, diapers, body wraps and the like.

### BACKGROUND OF THE INVENTION

In production of disposable absorbent articles, often it is necessary to space and turn various work pieces including various components of disposable absorbent articles. Further, these various work pieces often can be required to be spaced and turned to provide different or variable-pitch spacing between consecutive work pieces. However, in production of disposable absorbent articles, the conventional methods of spacing and turning of work pieces are often limited to a specific, fixed pitch at which the work pieces can be spaced and turned.

For example, one method of spacing and turning of pads is disclosed in U.S. Pat. No. 5,025,910 issued on Jun. 25, 1991. Although the disclosed method is capable of handling different pads of different width and length without making any mechanical changes or adjustments in the machine before switching from handling one pad size to another, the disclosed method is only capable of spacing the pads at a particular, fixed pitch for which a particular machine is designed and, thus, is not capable of spacing the pads at a variable-pitch range.

Because of the fixed-pitch limitation, the production of disposable absorbent articles can often include a multiplicity of pitch-dedicated machines, thus, resulting in a high capital cost, high maintenance cost, high “change over” cost for changing from one pitch to another, and the like.

Therefore, a method capable of providing variable-pitch spacing and turning of the work pieces in production of disposable absorbent articles would be beneficial to reduce the above cost-related problems. Furthermore, it would be beneficial for the above method being capable or performing the above steps in reverse, i.e. turning and variable pitch-spacing.

### SUMMARY OF THE INVENTION

The invention is directed to a method of variable-pitch spacing and turning or, reversibly, turning and variable-pitch spacing of work pieces in production of disposable absorbent articles, such as, feminine hygiene articles, diapers, body wraps, and the like, are disclosed. The work pieces can include any component of a disposable absorbent article, a combination of components forming a semi-finished product, or a finished product. The method includes the following steps:

(a) providing said work pieces consecutively;

(b) providing a spacing apparatus capable of spacing said work pieces at a variable pitch;

(c) providing a turning apparatus capable of turning said work pieces about an axis perpendicular to a plane of said work pieces;

(d) spacing said work pieces with the spacing apparatus from a first pitch to a second pitch; and

(e) turning said work pieces with said turning apparatus about said axis.

### BRIEF DESCRIPTION OF THE DRAWINGS

FIG. 1 is a process flow diagram illustrating the steps of variable-pitch spacing and turning of work pieces according to the method of the present invention, wherein all of the spaced and turned work-pieces become oriented in the same direction.

FIG. 2 is a process flow diagram of FIG. 1 wherein not all of the spaced and turned work-pieces become oriented in the same direction, for example, forming pairs of oppositely spaced work pieces.

FIG. 3 is a simplified perspective view of one embodiment of the method of present invention for variable-pitch spacing and turning or, reversibly, for turning and variable-pitch spacing, of work pieces in production of disposable absorbent articles.

### DETAILED DESCRIPTION OF THE INVENTION

As used herein, the following terms have the following meanings:

The term “work piece” refers herein to any component of a disposable absorbent article (for example, an absorbent core, a web sheet of a single or a multi-ply laminate including film, non-woven material, foam, and the like), a semi-finished, or a finished disposable absorbent article.

The term “disposable absorbent article” refers herein to a device that normally absorbs and retains fluids. In certain instances, the phrase refers to devices that are placed against or in proximity to the body of the wearer to absorb and contain the excreta and/or exudates discharged from the body, and includes such personal care articles as baby diapers, baby training pants, adult incontinence articles, feminine hygiene articles, baby swim diapers, wound dressing, and the like. In other instances, the phrase refers to protective articles, such as, for example, dining bibs that have the ability to absorb food items to prevent staining of the wearer's clothing.

The term “disposable” is used herein to describe products which generally are not intended to be laundered, otherwise restored, or extensively reused in their original function.

The term “semi-finished disposable absorbent article” refers herein to any individual part or combination of individual parts of a disposable absorbent article.

The term “finished disposable absorbent article” refers herein to a fully assembled disposable absorbent article prior to packaging.

The term “diaper” includes baby diapers, baby training pants, baby pool diapers, or adult incontinence articles and refers to a disposable fluid-handling article generally worn by infants and other incontinent persons about the lower torso.

The term “feminine hygiene articles” refers herein to any fluid-handling article worn by women to absorb and contain menses and other vaginal exudates.

The term “body wrap” refers herein to an article or a garment worn about the body, typically to provide some therapeutic benefit, such as, for example, pain relief, wound coverage or to hold another device or article near the body.

The term “web” is meant herein any continuous material, including a film, a non-woven fabric, a foam or a combination thereof, or a dry lap material including wood pulp, and the like, having a single layer or multiple layers.

The term “non-woven” refers herein to a material made from continuous filaments and/or discontinuous fibers, without weaving or knitting by processes such as spun-bonding and melt-blowing. The non-woven material can comprise one or more layers of non-woven material, wherein each layer can include continuous filaments or discontinuous fibers.

The term “foam” refers herein to any material comprising a solid, liquid crystalline, or liquid continuous phase and a gaseous dispersed phase. Because of the dispersed gaseous phase, a foam has a density less than the density of the continuous phase.

The term “film” refers herein to any polymeric film made by a process that includes extrusion of a polymeric material through a narrow slot of a die. The polymeric film can be impervious to a liquid and pervious to an air vapor.

The term “elastomer” refers herein to a polymer exhibiting elastic properties.

The term “elastic” refers herein to any material that upon application of a force to its relaxed, initial length can stretch or elongate to its elongated length without rupture and breakage, and which can substantially recover its initial length upon release of the applied force.

The term “natural material” means herein that a material derived from plants, animals, insects or byproducts of plants, animals, and insects. Non-limiting examples of natural materials useful in the disposable articles include cellulosic fibers, cotton fibers, keratin fibers, silk fibers and the like. Non-limiting examples of cellulosic fibers include wood pulp fibers, hemp fibers, jute fibers, and the like. Non-limiting examples of keratin fibers include wool fibers, camel hair fibers, and the like.

The term “machine direction” refers herein to a direction of travel of the work pieces in production of disposable absorbent articles.

The term “cross-machine direction” refers to a direction that is generally perpendicular to the machine direction.

The term “pitch” refers herein to a distance or space between individual work pieces, measured in the machine direction, wherein the pitch can be smaller, equal, or greater then the dimension of the work piece in the machine direction, i.e., when the work pieces are overlapping, contacting each other edges, or separated by a space that can vary within a desired range, thus, resulting in a “variable” or “flexible” pitch (each of the terms can be used herein).

The terms “spacing and turning” or “turning and spacing” refer herein to the steps comprising the process steps of the method of present invention and refer to both steps regardless of the consecutive order at which they performed, i.e., spacing and then turning or turning and then spacing.

The term “spacing” refers herein to any change in the pitch between work pieces, i.e., reducing or increasing the pitch between the adjacent work pieces.

The term “variable-pitch spacing” refers herein to the spacing capability wherein the pitch can vary within a certain suitable range, for example, from about 20 mm to about 450.

The term “orientation” refers herein to positioning of a work piece in relation to the machine direction, specifically, to positioning of a longitudinal dimension of a work piece in relation to the machine direction, including a “longitudinal orientation,” when the longitudinal dimension of the work piece is parallel to the machine direction, or a “lateral orientation,” when the longitudinal dimension of the work piece is perpendicular to the machine direction.

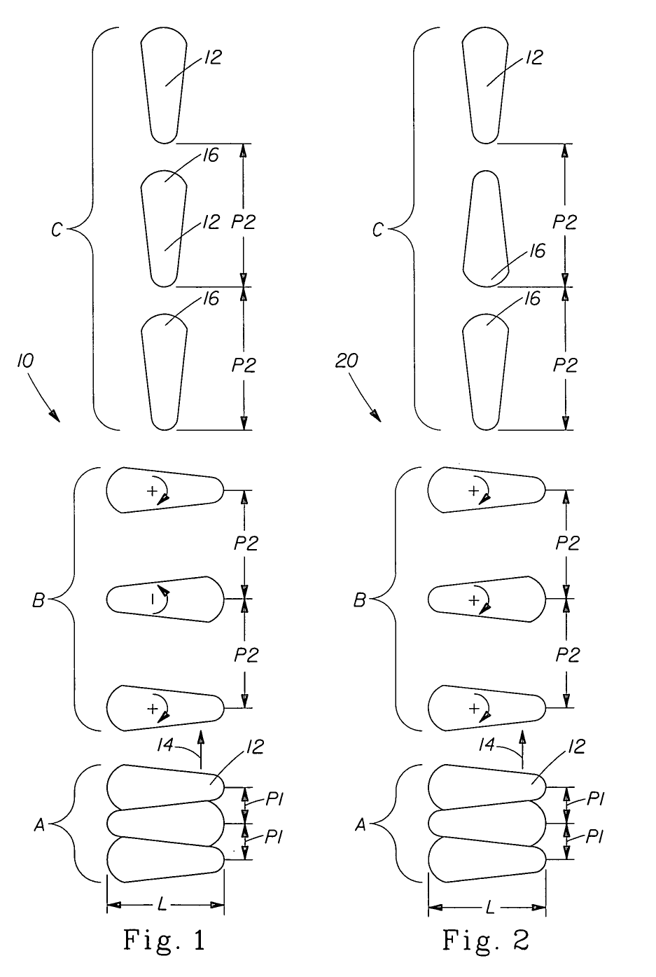

Referring to FIG. 1 showing a process flow diagram 10 illustrating the steps of the method of the present invention including variable-pitch spacing and turning of work pieces 12. In this example, the work pieces 12 are represented as absorbent cores that will be subsequently assembled with other components to produce finished feminine hygiene articles. However, as noted above, the work piece 12 of the present invention can include any component of a disposable absorbent article, or several components forming a semi-finished article, or even a finished disposable absorbent article.

As shown in FIG. 1, the work pieces 12 have a longitudinal dimension L. The process flow diagram 10 illustrates three orientations of the work-pieces 12: A, B, and C. In the orientation A, the work pieces 12 are shown “nested” with each other for material efficiency reasons after they were cut into individual work pieces from a continuous web (not shown). In the orientation A, the longitudinal dimension L of the work pieces 12 is preferably perpendicular to a machine direction 14. It should be noted, however, that the work pieces 12 could be disposed at any suitable configuration in relation to each other, e.g., “nested” as shown in FIG. 1 or not nested, being in contact with each other or apart from each other. The work pieces 12 are disposed at a first pitch P1. The first pitch P1 can include any suitable distance, for example, from about 20 mm to about 450 mm.

In the orientation B, the work pieces 12 are shown being oriented as in the orientation A, i.e., with their longitudinal dimension L being perpendicular to the machine direction 14. However, in the orientation B, the work pieces 12 are spaced from each other at a second pitch P2 which is preferable greater than the first pitch P1. It should be noted, however, that the second pitch P2 does not have to be always greater than the pitch P1. As such, the second pitch P2 can be also smaller than the first pitch P1 or equal to the first pitch P1. The second pitch P2 can vary and include, if desired, any suitable pitch between the work pieces 12, for example, from about 20 mm to about 450 mm.

In the orientation C, the work pieces 12 are also shown as being spaced at the same second pitch P2 as in the orientation B; however, the longitudinal dimensions L of the work pieces 12 are now parallel to the machine direction 14. Thus, for the orientation C, each work piece 12 was turned around the axis perpendicular to the plane of the work piece 12. In the orientation C of FIG. 1, the work pieces 12 are shown as being oriented in the same manner, wherein, for example, the wider side 16 of the work piece 12 is leading in the machine direction 14.

In order to provide the same orientation of the work pieces 12 in the orientation C, the work pieces 12 can be selectively turned from the orientation B in different directions (i.e., clockwise, indicated with a (+) and counter clockwise, indicated with (−) around an axis (not shown) that is perpendicular to the plane of the work piece 12. However, when desired, the work pieces 12 can be turned in the same direction (i.e., clockwise or counter clockwise), as shown, for example, in the orientation B of a process flow diagram 20 of FIG. 2, where all work pieces 12 are turned clockwise to orient the work pieces 12 with their wider side 16 being both leading and trailing in the machine direction 14, as shown in the orientation C1.

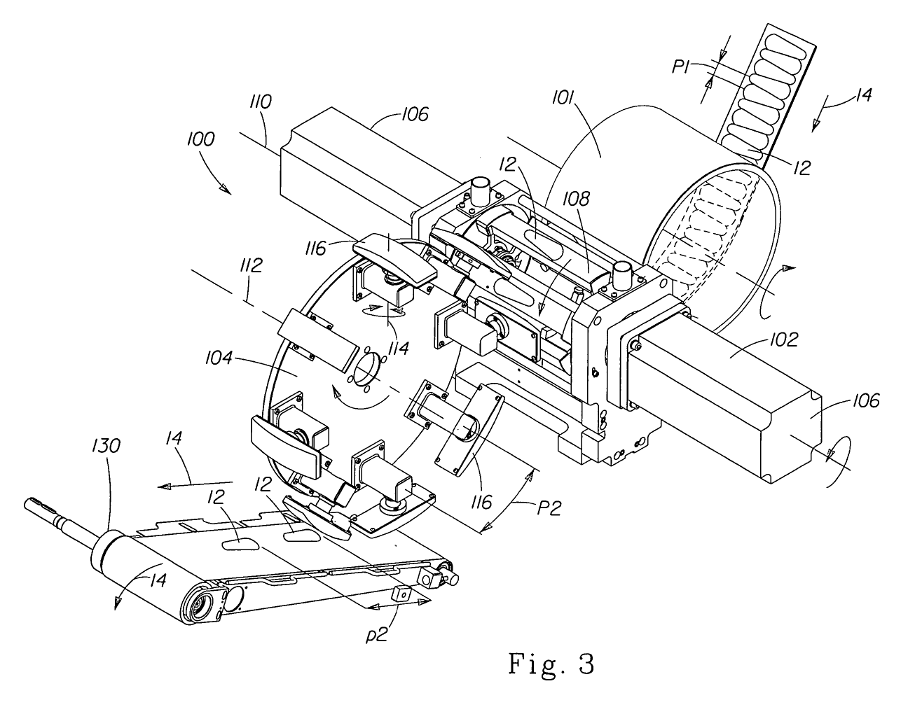

Referring to FIG. 3 which is a simplified perspective view of one embodiment 100 of the method of the present invention directed to manipulating individual work pieces 12 used in production of disposable absorbent articles to form at least one continuous row of these work pieces, wherein the work pieces 12 are spaced consecutively in the machine direction 14 at a pitch that can vary within a suitable range and, wherein, some or all of these work pieces 12 can be oriented parallel and/or perpendicular to the machine direction 14.

In FIG. 3, the method of the present invention is represented by the embodiment 100 comprising a spacing apparatus 102 and a turning apparatus 104 disposed preferably adjacent to each. Each of the spacing apparatus 102 and the turning apparatus 104 has an axis of rotation 110 and 112, respectively. These axes of rotation 110 and 112 are preferably parallel to each other and perpendicular to the machine direction 14, i.e., the direction of movement of the work pieces 12.

The spacing apparatus 102 of the present invention is capable of accepting the work pieces 12 provided to the spacing apparatus 102 at a first pitch P1 and then spacing them at a second pitch P2 (as shown also in FIGS. 1 and 2). As noted above, the first pitch P1 and the second pitch P2 can vary, and the first pitch P1 can be smaller or greater than the second pitch P2.

One embodiment of a spacing apparatus suitable as the spacing apparatus 100 of the present invention is disclosed in U.S. Pat. No. 6,450,321 issued to Blumenthal et al. Sep. 17, 2002 and titled “Method and Apparatus Utilizing Servo Motors For Placing Parts onto A Moving Web,” which is incorporated hereby by reference herein. The disclosed apparatus includes transferring devices capable of accepting individual parts (i.e., work pieces) at one speed and transferring these parts at a different speed that can vary within a desirable range, thus, effectively providing a desirable pitch spacing between these parts (i.e., work pieces).

The varying speed of the transferring devices of the disclosed apparatus of the above patent can be provided by suitable driving mechanisms, each comprising a servomotor and a transmitting mechanism. However, the spacing apparatus 102 of the present invention, as illustrated in FIG. 3, optionally, does not need to include the disclosed transmitting mechanisms, but, preferably, includes only servomotors 106 (FIG. 3), each being capable of rotating one or more transferring devices 108 around the axis 110 for spacing the work pieces 12 at a desired second pitch P2.

The work pieces 12 can be provided to the spacing apparatus 112 by any suitable means, wherein the work pieces 12 preferably form at least one continuous row and disposed at a pitch P1 from each other. For example, as shown in FIG. 3, the work pieces 12 can be provided by a rotating drum 101 carrying the work pieces 12. Further, the supplied work pieces 12 can be oriented in relation to the machine direction 14 at any suitable orientation, i.e., parallel, perpendicular, or at any orientation therebetween.

The transferring devices 108 of the spacing apparatus 102 can accept the supplied individual work pieces 12 and space them at a second pitch P2 (which, as noted above, can be greater or smaller than the first pitch P1). The pitch P2 can be any suitable pitch, for example, from about 20 mm to about 450 mm, which can be provided by the spacing apparatus 102.

Referring to FIG. 3, the spaced work pieces 12 then can be transferred from the spacing apparatus 102 to the turning apparatus 104 for turning the spaced work pieces 12 to change their initial orientation with respect to the machine direction 14. The turning apparatus 104 can be any apparatus suitable for turning individual work pieces 12 around an axis 114 perpendicular to the plane of the work pieces 12, in a desired direction of rotation, i.e., the clockwise or counter clockwise direction of rotation (as shown in FIG. 1). (However, it should be noted that the turning apparatus 104 can be any apparatus suitable not only for turning, but also for turning and spacing the individual work pieces 12. This spacing capability of the turning apparatus 104 can be in addition to the spacing capability of the spacing apparatus 102 to even further increase the total spacing capability of the method of the present invention.)

The turning apparatus 104 can have a multiplicity of rotating devices 116 spaced at a desired second pitch P2 capable of accepting the work pieces disposed at the second pitch P2 and then rotating the work pieces 12 around the axis 114, clockwise or counterclockwise, as desired. The desired spacing at the second P2 of the rotating devices 116 of the rotating apparatus 104 can be provided by a controlled radial movement of the rotating devices 116 along the axis 114 by any suitable means. Alternatively or in combination, the desired spacing of the rotating devices 116 at the second pitch P2 can be provided by the use of spacers for adjusting the radial position of the turning devices 116.

The turning apparatus 104 of the present invention can be any apparatus suitable for turning the work pieces used in production of disposable absorbent articles. For example, a suitable turning apparatus can be acquired, for example, from the following manufacturers: Fameccanica.Data S.p.A.-66020 Sambuceto di San Giovanni Teatino (CH) Italyor; Curt G. JOA, Inc. of Wisconsin; and Zuiko Corporation of Japan.

Referring to FIG. 3, after the turning step of the wok pieces 12 around the axis 14 clockwise and/or counter clockwise, the work pieces 12 can be discharged on a moving surface 130 which can including any suitable conveyor belt, drum, or moving web.

In FIG. 3, the machine direction 14 is shown by the arrow directed from the spacing apparatus 102 to the turning apparatus 104; however, reversely, the machine direction 14 can be also directed from the turning apparatus 104 to the spacing apparatus 102.

Further, the work pieces 12 of the method of the present invention can be supplied in a direction that is reversed to the shown direction 14 of FIG. 3. In the reverse condition, the work pieces 12 can be supplied first to the turning apparatus 104 and not the spacing apparatus 102. For this, the work pieces 12 can be supplied as being disposed at a second pitch P2 and then, after the turning step in the turning apparatus 104, the work pieces 12 can be transferred to the spacing apparatus 102, where the turned work pieces 12 can be spaced at a first pitch P1, which can be greater or smaller that the second pitch P2.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A method of variable-pitch spacing and turning or, reversibly, turning and variable-pitch spacing of work pieces in production of disposable absorbent articles, comprising the steps of:
(a) providing said work pieces disposed at a first pitch between each other;
(b) providing a spacing apparatus capable of changing said first pitch to a second pitch;
(c) providing a turning apparatus capable of turning said work pieces about an axis perpendicular to a plane of said work pieces, said turning apparatus having rotating devices spaced at said second pitch capable of changing by a radial movement of said rotating devices;
(d) spacing said work pieces with the spacing apparatus from said first pitch to said second pitch; and
(e) turning said work pieces with said turning apparatus about said axis.

2. The method of claim 1 wherein said disposable absorbent articles are feminine hygiene articles, diapers, and body wraps.

3. The method of claim 1 wherein said work pieces are individual components of disposable absorbent articles, combinations of components forming semi-finished or finished disposable absorbent articles.

4. The method of claim 3 wherein said individual components of disposable absorbent articles include absorbent cores, single sheets, or laminated sheets.

5. The method of claim 1 wherein said first pitch is smaller than said second pitch.

6. The method of claim 1 wherein said first pitch is greater than said second pitch.

7. The method of claim 1 wherein step (d) precedes step (e).

8. The method of claim 1 wherein step (e) precedes step (d).

9. The method of claim 1 wherein said first pitch is variable from about 20 mm to about 450 mm.

10. The method of claim 1 wherein said second pitch is variable from about 20 mm to about 450 mm.

11. The method of claim 1 wherein the step of turning includes clockwise turning and/or counter clockwise turning.

12. The method of claim 1 wherein said turning apparatus is capable of spacing said work pieces.
